(19) United States
(12) Patent Application Publication
(10) Pub. No.: US 2001/0031363 A1
(43) Pub. Date: Oct. 18, 2001

(54) Polyurethane formulation for coating substrates

(76) Inventors: Harro Traubel, Leverkusen (DE); Karl Pisaric, Pulheim (DE); Michael Traubel, Koln (DE)

Correspondence Address: BAYER CORPORATION, PATENT DEPARTMENT, 100 BAYER ROAD, PITTSBURGH, PA, 15205, US

(21) Appl. No.: 09/780,092

(22) Filed: Feb. 9, 2001

Related U.S. Application Data
(63) Continuation-in-part of application No. 09/350,496, filed on Jul. 9, 1999, now abandoned.

(30) Foreign Application Priority Data
Jul. 17, 1998 (DE) 19832173.2

(51) Int. Cl. B32B 27/40

(52) U.S. Cl. 428/423.4; 428/425.1; 428/332; 528/48; 524/591; 427/323; 427/326

(57) ABSTRACT

This invention relates to aqueous polyurethane formulations comprising

(a) at least one dispersed polyurethane not having groups that can react with NCO groups to form additional urethane or urea functionalities, and

(b) at least one NCO prepolymer based on a polyester polyol and/or a polyether polyol, that are particularly suitable for producing thick coatings on substrates such as split leather or textiles.

This application is a continuation-in-part of application Ser. No. 09/350,496, filed Jul. 9, 1999.

### BACKGROUND OF THE INVENTION

The invention relates to polyurethane formulations, to a process for preparing them, to substrates coated with them, and to a corresponding coating process.

Substrates such as, for example, leather and textiles, provided with thick polyurethane coats in a thickness of greater than 0.1 mm are used, for example, for shoe upper materials and for articles as employed, for example, in automotive interior trim. Depending on the substrate, even thicker coatings may be necessary. For example, when substrates with an irregular surface, such as nonwovens or split leather, are used, it is impossible to provide sufficient coverage of this irregular surface with thin coatings, and so it becomes unattractive (orange peel) especially when stretched.

In general, thick polyurethane coatings can be produced in a variety of ways. For example, it is possible to use high-solids systems—that is, mixtures with a high solids content—comprising blocked isocyanate prepolymers with cycloaliphatic amines in order to produce thick coatings (see DE-A 3,313,237).

The two components are mixed with one another to form a mixture which is stable for a prolonged period of time. This mixture is then used to coat substrates on conventional coating lines. On these lines, the mixture is coated, for example, onto a release paper as a temporary support and heated, whereupon the blocking agent is eliminated and the polyurethane is formed. A disadvantage of this method in the case of the production of thick coatings is that the blocking agent does not all escape immediately from the coat that is formed and so can still be detected on the surface of the coating by gas chromatography even after a relatively long period of use.

A further possibility for producing relatively thick polyurethane coatings comprises the foam coatings as are described, for example, in U.S. Pat. No. 3,713,868. These aqueous dispersions, which include blowing agents, can be employed, for example, on conventional textile coating lines. The disadvantage of thick coatings produced in this way is that the physical properties of the coating, such as the tensile strength, the tear propagation resistance and the flexibility, fail to satisfy the requirements made of them. Furthermore, relatively complex drying units are required in order to evaporate the water which, owing to the foam structure, is located in a kind of insulating layer.

A further possibility of producing thick polyurethane coatings which exists is that of so-called reactive coating, in which a special apparatus is used in which the highly reactive co-reactants are mixed in precise proportions and immediately applied by spraying to a temporary release support or to the substrate itself. However, a disadvantage of this process is the great complexity of the apparatus (H. Träubel et al., J. Coated Fabrics, 1986, pp. 250-262).

It was therefore the object of the present invention to provide a polyurethane formulation with which it is possible to provide substrates with thick coatings while avoiding the disadvantages depicted above.

### SUMMARY OF THE INVENTION

The invention therefore relates to aqueous polyurethane formulations comprising

(a) at least one dispersed polyurethane not having groups that can react with NCO groups to form additional urethane or urea functionalities, and

(b) at least one NCO prepolymer based on a polyester polyol and/or a polyether polyol.

### DETAILED DESCRIPTION OF THE INVENTION

For the purpose of this invention, groups that, if present, could react with NCO groups to form additional urethane or urea functionalities include alcohol hydroxyl groups, amino groups having NH₂ or NH functionalities, or mercaptan sulfhydryl groups.

By NCO prepolymer is meant, for the purposes of this invention, a polyurethane that contains NCO groups.

Based on polyester polyol and/or polyether polyol implies that the NCO prepolymer of component (b) has been prepared by reacting polyisocyanate compounds with polyester polyols and/or polyether polyols, but does not exclude further NCO-reactive compounds, such as monoalcohols and mono- and polyamines, as additional reactants.

By dispersed polyurethane is meant, for the purposes of this specification, both self-dispersing polyurethanes and polyurethanes dispersed with the aid of dispersants.

Examples of possible dispersants are cationic, anionic, amphoteric and nonionic dispersants. Preferably, however, the polymer of component (a) is self-dispersing.

As self-dispersing polyurethanes of component (a) it is preferred to employ those which possess their dispersing property on the basis of incorporated—that is, incorporated by addition copolymerization or by polyaddition—water-solubilizing groups, especially carboxylate groups, sulfonate groups and/or quaternary ammonium groups. These groups can be incorporated into the polymer by using, for example, the corresponding monomers. Examples of such monomers for polyurethanes are dimethylolpropionic acid, an adduct of ethoxylated or non-ethoxylated butenediol and sodium sulfite, and C₁-C₄-alkyl-C₁-C₄-dialkanolamine, such as methyl-diethanolamine, for example.

A good self-dispersing ability is possessed by homopolymers having water-solubilizing groups or by copolymers which comprise the monomer having water-solubilizing groups in an amount of from 1 to 10% by weight based on the copolymer. For polyurethanes, this amount of polyol, polyamine, monoalcohol and/or monoamine carries water-solubilizing groups, based on the polyurethane.

Particular preference is given to self-dispersing polyurethanes, alone or in mixtures with polyacrylates or polymethacrylates. Particular preference is given to polyurethanes for which the polyol or polyamine component gives a polyurethane or polyurea that is stable to hydrolysis. In this context, particular mention may be made of polycaprolactone, polycarbonate, and polyethers. The optional polyacrylates and polymethacrylates can be composed of the usual monomers, examples being methyl (meth)acrylate, butyl (meth)acrylate, ethyl (meth)acrylate and/or (meth)acrylic acid.

The isocyanate component in polyurethane polymers of component (a) preferably comprises aliphatic isocyanates, which preferably possess an average NCO functionality of 1.8 or more, in particular from 1.8 to 4.

The preferred polyurethanes of component (a), especially self-dispersing polyurethanes, have, in the form of their film, a Shore A hardness of from 30 to 90, in particular from 40 to 80.

Particularly preferred polymers are those having an average molecular weight of 500 to 5000, in particular from 1000 to 3000 and, with particular preference, from 1000 to 2000 g/mol.

The polyether- and/or polyester-NCO prepolymers of component (b) are obtained by reacting isocyanate compounds with corresponding polyether polyols and/or polyester polyols.

As the isocyanate prepolymers of component (b) of the polyurethane formulation of the invention it is preferred to employ those having an average molecular weight of more than 500 g/mol, in particular more than 1000 g/mol and, with particular preference, more than 1500 g/mol. It is likewise preferred to employ those having a molar weight of less than 10,000 g/mol. Although the molar weight can also be higher than this, it is then generally necessary to compensate the associated increase in viscosity by adding solvent.

The term “average molecular weight” for the purposes of the invention denotes the molecular weight determined as the numerical average.

The NCO content of the NCO prepolymer of component (b) that is employed is preferably from 1 to 20, in particular from 2 to 8 and, with particular preference, from 2.5 to 5% by weight, based on the NCO prepolymer.

For synthesizing the NCO prepolymers of component (b) that are to be employed, suitable NCO-containing compounds are preferably polyisocyanates having an average NCO functionality of 1.8 or more. These are, for example, aliphatic, aromatic and heterocyclic polyisocyanates, examples being ethylene diisocyanate, 1,4-tetramethylene diisocyanate, 1,6-hexamethylene diisocyanate, 1,12-dodecane diisocyanate, cyclobutane-1,3-diisocyanate, cyclohexane 1,3- and 1,4-diisocyanate and any desired mixtures of these isomers, 1-isocyanato-3,3,5-trimethyl-5-isocyanatomethyl-cyclohexane, 2,4- and 2,6-hexahydrotoluene diisocyanate and any desired mixtures of these isomers, hexahydro-1,3- and/or -1,4-phenylene diisocyanate, perhydro-2,4′- and/or -4,4′-diphenylmethane diisocyanate, 1,3- and 1,4-phenylene diisocyanate, 2,4- and 2,6-toluene diisocyanate and any desired mixtures of these isomers, diphenylmethane 2,4′- and/or 4,4′-diisocyanate, naphthylene 1,5-diisocyanate, triphenylmethane 4,4′,4″-triisocyanate, polyphenylpolymethylene polyisocyanates as obtained by aniline-formaldehyde condensation with subsequent phosgenization, m- and p-isocyanatophenylsulfonyl isocyanates, perchlorinated aryl polyisocyanates, polyisocyanates containing carbodiimide groups, diisocyanates, polyisocyanates containing allophanate groups, polyisocyanates containing isocyanurate groups, polyisocyanates containing urethane groups, polyisocyanates containing acylated urea groups, polyisocyanates containing biuret groups, polyisocyanates prepared by telomerization reactions, polyisocyanates containing ester groups, reaction products of the above-mentioned isocyanates with acetals, and polyisocyanates containing polymeric fatty acid radicals.

It is also possible to employ—either as they are or dissolved in one or more of the above-mentioned polyisocyanates—the distillation residues which are obtained in the industrial manufacture of isocyanates and which contain isocyanate groups. A further possibility is to use any desired mixtures of the above-mentioned polyisocyanates.

Preference is given to the use of 1-isocyanato-3,5,5-trimethyl-5-isocyanatomethylcyclohexane, perhydro-4,4′-diphenylmethane diisocyanate, the isomeric toluene diisocyanates, 4,4′-diphenylmethane diisocyanate, 1,6-hexamethylene diisocyanate, trimeric toluene diisocyanate, the reaction product of 1 mol of trimethylolpropane and 3 mol of toluene diisocyanate, and the mixed trimer of 3 mol of toluene diisocyanate and 2 mol of hexamethylene diisocyanate.

For the preparation of the isocyanate prepolymers of component (b) it is possible, accordingly, to employ all usual isocyanates. Preferred isocyanate compounds on which the NCO prepolymer is based as component (b) are 4,4′-diisocyanatodiphenylmethane (MDI), toluene diisocyanates (TDI), hexamethylene diisocyanate (HDI) and isophorone diisocyanate (IPDI). Perhydrogenated isocyanates, such as dicyclohexylmethane-4,4′-diisocyanate (H12MDI) or perhydrogenated TDI and the like, can likewise be employed. Preferably, however, these products are used in mixtures with other isocyanates.

Suitable co-reactants for the above-mentioned polyisocyanates for preparing the NCO prepolymers are, as polyols, polyester polyols and/or polyether polyols as known per se for the preparation of homogeneous polyurethanes and cellular polyurethanes.

Particular preference is given to NCO prepolymers based on polyether polyols and polyester polyols where the ratio of polyether polyol to polyester polyol is preferably from 30:70 to 70:30. In one particularly preferred embodiment the proportion of the polyether polyol is greater than that of polyester polyol.

Preferred polyethers are homopolymers or block polymers of alkylene glycol ethers, especially polyethylene glycol ethers, polypropylene glycol ethers, polyethylene polypropylene glycol mixed ethers or mixtures thereof.

A preferred polyether is polypropylene glycol ether containing (i.e., including in polyadduct or admixed form) up to 80% by weight, preferably up to 40% by weight, of ethylene oxide or polytetramethylene glycol ether.

Examples of polyester polyols are reaction products of polyhydric, preferably dihydric and optionally, in addition, trihydric alcohols with polybasic, preferably dibasic, carboxylic acids. In place of the free polycarboxylic acids it is also possible to use the corresponding polycarboxylic anhydrides or corresponding polycarboxylic esters of lower alcohols, or mixtures thereof, in order to prepare the polyesters. The polycarboxylic acids can be aliphatic, cycloaliphatic, aromatic and/or heterocyclic in nature and may optionally be substituted, for example by halogen atoms, and/or unsaturated.

Examples of such compounds that may be mentioned are succinic acid, adipic acid, suberic acid, azelaic acid, sebacic acid, phthalic acid, isophthalic acid, trimellitic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric and trimeric fatty acids such as oleic acid, alone or with a mixture of monomeric fatty acids, dimethyl terephthalate, and bisglycol terephthalate.

Examples of polyhydric alcohols are ethylene glycol, 1,2- and 1,3-propanediol, 1,4- and 2,3-butanediol, 1,6-hexanediol, 1,8-octanediol, neopentyl glycol, cyclohexanedimethanol (1,4-bis-hydroxymethyl-cyclohexane), 2-methyl-1,3-propanediol, glycerol, trimethylolpropane, 1,2,6-hexanetriol, 1,2,4-butanetriol, trimethylolethane, pentaerythritol, quinitol, mannitol and sorbitol, methylglycoside, and also diethylene glycol, triethylene glycol, tetraethylene glycol, dipropylene glycol, dibutylene glycol and polybutylene glycols.

It is preferred to employ mixed esters of adipic acid with hexanediol and neopentyl glycol, it being possible for the molar ratio of the polyols to vary from 2:8 to 8:2. Polycarbonates of hexanediol (preferably in a mixture with crystallization-inhibiting glycols) and of di- to tetraethylene glycol can likewise be used for preparing the NCO prepolymer. Both polyesters and polyethers may, for example, increase an OH functionality by way of compounds with a functionality of three or more which are incorporated by condensation, such as trimethylolpropane and pentaerythritol; in particular, they may increase the OH functionality to≧2, preferably to≧2 to 4.

The ratio of NCO prepolymers to the dispersed polymers in the polyurethane formulation of the invention is preferably from 1:10 to 10:1 and, in particular, from 0.5:1 to 3:1. The aqueous polyurethane formulations of the invention preferably include from 20 to 90, in particular from 40 to 60% by weight of dispersed polymer of component (a) and from 10 to 80, in particular from 20 to 60% by weight of the NCO prepolymer of component (b), based in each case on the formulation. The polyurethane formulation of the invention may additionally comprise further additives. Examples are catalysts which accelerate the isocyanate-water reaction and may be employed preferably in an amount of from 1 to 5% by weight based on the polyurethane formulation. Suitable catalysts include tertiary amines, such as dimethyl-benzylamine, diazabicyclooctane, tin compounds, such as tin dioctoate, dibutyltin dilaurate, cobalt naphthenate, and the customary catalysts employed for urethanization. It is preferred not to employ any catalyst. For NCO prepolymers based on polyester polyols, particular preference is given to catalysts that are free from heavy metals. It is also possible to employ colorants, especially pigments and/or dyes, preferably from 0 to 20% by weight, based on the polyurethane formulation. Furthermore, it is possible to add any other pigments, fillers, light stabilizers and hydrolysis stabilizers, antioxidants, flame retardants, antistatics, leveling assistants, defoamers, fungicides and bactericides, handle agents and similar additives that are known per se. The leveling agents are employed preferably at up to 5%. Examples of suitable such agents are organic silicone compounds. A feature of the polyurethane formulations of the invention is that they do not require complex apparatus to produce the coating.

The invention additionally provides a process for preparing the polyurethane formulations of the invention, characterized in that at least one NCO prepolymer based on polyester polyol and/or polyether polyol, and, if desired, further additives, is introduced into an aqueous polymer dispersion of a polymer which carries no NCO-reactive amino groups.

The polyurethane preparation of the invention is prepared by mixing the dispersed polymer of component (a), NCO prepolymers of component (b), water and, if desired, further additives. Mixing preferably takes place using stirrers, especially high-speed stirrers, in continuous mixing apparatus, or by means of simple stirrers as conventional, for example, in the art of decorating.

In one preferred embodiment, the water-dispersed polymer of component (a) is introduced initially and the prepolymer and any further additives are mixed in with stirring.

The preparation of the invention takes place preferably at a temperature from 15 to 30° C., preferably at room temperature.

The invention additionally provides coated substrates constructed from

(a) a substrate,

(b) an adhesion layer H, which is adjacent to the substrate and is formed by curing an aqueous polyurethane formulation according to the invention,

(c) if desired, a top layer D that is either directly adjacent to the adhesion layer or separated from the adhesion layer by one or more interlayers,

(d) optionally, one or more interlayers between the adhesion layer and the top layer.

Suitable substrates are primarily flat substrates, preferably leather, especially split leather, and also materials comprising natural and/or synthetic fibers, such as nonwovens, wovens, knits and paper. Particular preference is given to leather, preferably split leather.

The coating thickness of adhesion layers, optional top layers and interlayers together is preferably more than 0.05 mm, in particular from 0.1 to 3 mm. With particular preference, the thickness of the adhesion layer H is more than 0.1 mm.

Suitable possible top layer (c) and also interlayers (d) are preferably polyurethane layers having a Shore A hardness of more than 60. These polyurethanes are used conventionally.

Other polymer materials as well, examples being acrylates, nitrocellulose, polyamide acid and acetobutyrate, can be used for the top layer, the layer formed from these materials also preferably having a Shore A hardness of≧60.

The coated substrates of the invention preferably possess good low-temperature flexibility, abrasion resistance and tensile strength. In addition, they do not emit any blocking agents.

The invention additionally provides a process for producing the substrates coated in accordance with the invention, by

(i) applying a polyurethane formulation to a substrate and curing the polyurethane formulation on the substrate, or

(ii) applying a polyurethane formulation, with or without a top layer D and with or without one or more interlayers, to a temporary support, inserting a substrate into the layer formed by the polyurethane formulation, and subsequently curing the polyurethane formulation.

The coating process of the invention can, therefore, be performed as direct coating (i) or as reverse coating (ii). In the case of reverse coating, first, the top layer is preferably applied to a support, for example to a release paper, this layer is dried, and any further top layers (interlayers) are applied, it being possible to apply the hardest top layer first and each further top layer subsequently in decreasing order of its hardness, and then, preferably, the polyurethane formulation of the invention for the adhesion layer H is applied to the dried top layer(s). The substrate to be coated is then inserted into this layer which has been formed, and which is preferably still moist. Following the curing of the adhesion layer, the temporary support is preferably removed from the top layer, so that, therefore, the first layer applied to the support becomes the outer layer of the substrate to be coated. Since leather is a material which is particularly unlevel, it was particularly surprising that this procedure results in a useful coating even on leather. In a preferred embodiment of the coating process of the invention, the starting materials for the respective layers are preferably chosen so that the adhesion layer H is softer than the top layer D. The adhesion layer H preferably has a Shore A hardness of from 25 to 75 and the top layer D preferably has a Shore A hardness of from 50 to 100, the difference in hardness between the two layers being in particular more than 10 Shore A.

Preference is likewise given to a variant process in which not only the top layer D but also one or more interlayers are applied, it being possible for up to 4 interlayers to be useful. In this case the individual interlayers likewise have a Shore A hardness of preferably from 50 to 100. Preferably, the difference in hardness between the softer interlayer adjacent to the adhesion layer H and each adjacent interlayer further removed from the adhesion layer is at least 10 Shore. In addition, the difference between any further adjacent interlayers and/or top layers is preferably 10 Shore A, the top layer or interlayer which is softer in each case being closer to the adhesion layer than the harder top layer(s) and/or interlayer(s).

With particular preference, the process of the invention is operated as a reverse coating process (ii), in which the temporary supports are used. Examples of suitable temporary supports are silicone matrices or other releasable materials. However, the process of the invention can be performed with particular advantage on textile coating machines, with release paper. The adhesion layer is preferably cured at a temperature of from 50 to 80° C. The coatings obtained in this way have the following advantageous properties, especially at layer thicknesses of more than 0.1 mm.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all percentages are percentages by weight.

### EXAMPLES

The materials used in the following examples are described below:

### Polyurethane dispersions

Dispersion 1

50% linear aliphatic, anionic PU dispersion containing adipic-acid-based polyester soft segments, hydrophilic sodium sulfonate groups, and polyurea hard segments but no hydroxyl and no amino functionalities, with the following characteristics:

Shore A hardness 62; 100% modulus 2 MPa, tensile strength 20 MPa; elongation at break 700% (DIN 53 504)

Dispersion 2

40% slightly branched anionic, aliphatic PU dispersion containing polyester soft segments, hydrophilic sodium sulfonate groups, and carbazide type hard segments but no hydroxyl and no amino functionalities, with the following characteristics:

Shore A hardness 95; 100% modulus 20 MPa, tensile strength 40 MPa; elongation at break 300%

Dispersion 3

40% slightly branched aliphatic, anionic PU dispersion containing polyester soft segments, polyurea type hard segments, and (triethylamine neutralized) hydrophilic carboxyl groups but no hydroxyl and no amino functionalities, with the following characteristics:

Shore A hardness 60; 100% modulus 6 MPa, tensile strength 34 MPa; elongation at break 500%

Dispersion 4

40% linear anionic, aliphatic PU dispersion containing mixed polycarbonate/polyether soft segments, polyurea type hard segments, and hydrophilicity introduced via a synergistic mixture of (triethylamine neutralized) carboxyl groups, sodium sulfonate groups, and hydrophilic polyether but no hydroxyl and no amino functionalities, with the following characteristics:

Shore A hardness 65; 100% modulus 2.5 MPa, tensile strength 20 MPa; elongation at break 500%

Dispersion 5

40% linear anionic, aliphatic PU dispersion containing polyester soft segments, urethane hard segments, and hydrophilic sodium sulfonate groups but no hydroxyl and no amino functionalities, with the following characteristics:

Shore A hardness 93; 100% modulus 5 MPa, tensile strength 35 MPa; elongation at break 600%

Dispersion 6

30% slightly crosslinked anionic, aliphatic PU dispersion containing mixed polyether/polycarbonate soft segments, polycarbazide type hard segments, and (triethylamine neutralized) hydrophilic cyanourea groups but no hydroxyl and no amino functionalities, with the following characteristics:

Shore A hardness 70; 100% modulus 4.2 MPa, tensile strength 42 MPa; elongation at break 560%

### Prepolymers

NCO prepolymer 1

80% strength solution in ethyl acetate of an NCO prepolymer having an NCO content of 3.7% and prepared from a trifunctional polyether (MW Mₙ 4800) and 4,4′-methylenedi(phenylisocyanate) (MDI) isomer mixture.

NCO prepolymer 2

80% strength solution in ethyl acetate of a prepolymer as described under NCO prepolymer 1, having an NCO content of 3.7%, but prepared using 20% (based on the polyether) of a difunctional polyadipate of Mₙ 1700.

NCO prepolymer 3

80% strength solution in toluene of an NCO prepolymer having an NCO content of 3.6% and prepared from a hexanediol/neopentyl glycol polyadipate (Mₙ 1700) and toluene diisocyanate) (TDI) isomer mixture.

### Auxiliaries and additives

H1) Beechwood flour, average particle size 10 micrometers.

H2) Casein-free aqueous pigment preparations of low binder content.

H3) Polyether-modified and hence water-dispersible hexamethylene diisocyanate (HDI) trimer, 80% strength in propylene glycol diacetate, having an NCO content of 12.6%.

H4) Silicate formulation of low binder content which can be incorporated into binder mixtures; solids content 23%.

H5) Water-dispersible/soluble silicone formulations.

H6) Water-dispersible formulation of an associative PU thickener, active-substance content 8%.

H7) Diazabicyclo[2.2.2]octane (DABCO).

### Example 1

An aqueous paste was prepared from 160 g of Dispersion 1,12 g of H1 and 10 g of the black pigment preparation H2.70 g of the NCO prepolymer 3 were introduced into this paste with stirring at about 800 rpm. The resultant dispersion has a viscosity of 1000 mPas at the time of stirring together. After 1 hour at room temperature the viscosity rose to 1800, after 3 hours to 2000, and after 5.5 hours to 2500 mPas.

a) This paste was applied using a spray gun at a rate of 250 g/m² (wet) to a standard sheet of release paper provided with a prefinish (15 g/m² solids) comprising 70 g of Dispersion 2, 30 g of Dispersion 3 and 1.5 g of H5, a split leather was inserted, and the assembly was dried at 70° C. for 4 minutes. After cooling to room temperature, the release paper was removed. The surface was still slightly tacky, although this tackiness disappeared completely after the coated leather had been suspended in air for 14 h. The same mixture was also processed again after storage at room temperature for three hours and used for coating as above. There were no differences. The coat thickness in Example 1a) is more than 0.15 mm.

b) A further portion of this paste was coated at a rate of about 150 g/m² (wet) onto a release paper prefinished as above, and a woven cotton fabric was inserted. After the assembly had passed through a drying tunnel at a temperature from 80 to 125° C. and, finally at 135° C., the coated woven was removed from the release paper. The coat thickness in Example 1 b) is 0.19 mm.

### Examples 2 to 6

The procedure of Example 1 was used to coat split leather in Examples 2, 4a, 5 and 6, microfiber nonwoven in Example 3, and woven cotton fabric in Example 4b. This was done using a top coating material, optionally an intermediate coating material, and an adhesion coating material of the following composition:

| | TABLE | | | | |
|---|---|---|---|---|---|
| | (Amounts in g) | | | | |
| | Ex. 2 | Ex. 3 | Ex. 4a/b | Ex. 5 | Ex. 6 |
| Top coating material | | | | | |
| Dispersion 2 | 600 | 800 | 500 | 500 | 1000 |
| Dispersion 4 | 400 | 200 | — | — | — |
| Dispersion 6 | — | — | 500 | 500 | — |
| H2 (black) | 80 | 80 | — | 150 | 200 |
| H4 | 50 | 50 | — | — | — |
| H5 | — | — | 10 | 10 | — |
| H6 | 40 | 50 | 80 | 80 | 100 |
| Knife gap (mm) | 0.04 | 0.04 | Air knife | | |
| Solids add on/(g/m²) | 15 | 15 | 8 | 15 | 15 |
| Coat thickness (mm) | 0.015 | 0.015 | 0.008 | 0.015 | 0.015 |
| Drying temperature (° C.) | 80-120 | 80-120 | 80-150 | | |
| Intermediate coating material | | | | | |
| Dispersion 4 | 1000 | — | — | 1000 | 1000 |
| H2 (black) | 80 | — | — | — | — |
| H2 (red) | — | — | — | 200 | 200 |
| H3 | 30 | — | — | 30 | 25 |
| H4 | — | — | — | 50 | 50 |
| H6 | 35 | — | — | 40 | 40 |
| Knife gap (mm) | 0.20 | — | — | 0.08 | 0.08 |
| Solids addon (g/m²) | 50 | — | — | 30 | 30 |
| Coat thickness (mm) | 0.05 | — | — | 0.03 | 0.03 |
| Drying temperature (° C.) | 80-95 | — | — | 80-150 | 80-150 |
| Adhesion coating material | | | | | |
| Dispersion 1 | 160 | 160 | 160 | 160 | 160 |
| Dispersion 5 | 20 | 20 | 20 | 20 | 20 |
| Prepolymer 1 | — | 70 | 70 | — | — |
| Prepolymer 2 | 70 | — | — | — | — |
| Prepolymer 3 | — | — | — | 50 | 40 |
| H1 | 12 | 12 | 12 | 12 | 12 |
| H2 (black) | 10 | 10 | 10 | 10 | 10 |
| H7 | — | — | 0.01 | 0.01 | — |
| Knife gap (mm) | 0.13 | 0.13 | 0.19 | 0.19 | 0.19 |
| Solids addon (g/m²) | 130 | 130 | 150 | 150 | 150 |
| Coat thickness (mm) | 0.13 | 0.13 | 0.15 | 0.15 | 0.15 |
| Drying temperature (° C.) | 90-95 | 90-95 | 85-95 | 85-95 | 85-95 |
| Overall coat thickness (mm) | 0.195 | 0.145 | 0.158 | 0.195 | 0.195 |

The physical properties from Examples 2 and 3, tested as a film of the following thickness, are as follows:

| Properties | Ex. 2 | Ex. 3 |
|---|---|---|
| Coat thickness | 0.14 | 0.13 |
| (mm) | | |
| Tensile strength to DIN 53504 | 2 | 1.9 |
| (MPa) | | |
| Elongation at break | 110 | 112 |
| (%) | | |
| Tear propagation resistance to | 1.0 | 0.6 |
| DIN 53356 | | |
| (dN/cm) | | |

Physical properties of the coated articles:

| Properties | Ex. 1a) | Ex. 1b) | Ex. 2 | Ex. 3 | Ex. 6 |
|---|---|---|---|---|---|
| Crease resistance | | | | | |
| to DIN 53351 | | | | | |
| dry | 100,000 | 100,000 | 100,000 | 100,000 | 100,000 |
| wet | >20,000 | 20,000 | >50,000 | >50,000 | |
| cold (−30° C.) | | | 10,000 | 10,000 | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane formulation comprising
(a) at least one dispersed polyurethane not having groups that can react with NCO groups to form additional urethane or urea functionalities, and
(b) at least one NCO prepolymer based on a polyester polyol and/or a polyether polyol.

2. A polyurethane formulation according to claim 1 wherein the NCO prepolymer of component (b) has a numerical average molecular weight of more than 500 g/mol.

3. A process for preparing a polyurethane composition according to claim 1 comprising introducing an NCO prepolymer based on a polyester polyol and/or a polyether polyol and optional additives into an aqueous polymer dispersion of a polymer having no NCO-reactive amino groups.

4. A coated substrate comprising
(a) a substrate,
(b) an adhesion layer adjacent to the substrate, wherein the adhesion layer is formed by curing an aqueous polyurethane formulation according to claim 1,
(c) optionally, a top layer either directly adjacent to the adhesion layer or separated from the adhesion layer by one or more interlayers, and
(d) optionally, one or more interlayers between the adhesion layer and the top layer.

5. A coated substrate according to claim 4 wherein the substrate is leather or a material comprising natural and/or synthetic fibers.

6. A coated substrate according to claim 4 wherein the substrate is split leather.

7. A coated substrate according to claim 4 wherein the substrate is a nonwoven, woven, knit, or paper material comprising natural and/or synthetic fibers.

8. A coated substrate according to claim 4 wherein the overall coating thickness of the adhesion layer, optional top layer, and optional interlayers is greater than 0.1 mm.

9. A process for preparing a coated substrate comprising
(a) a substrate,
(b) an adhesion layer adjacent to the substrate,
(c) optionally, a top layer either adjacent to the adhesion layer or separated from the adhesion layer by one or more interlayers, and
(d) optionally, one or more interlayers between the adhesion layer and the top layer,
comprising
(i) applying a polyurethane formulation according to claim 1 to a substrate and curing the polyurethane formulation on the substrate; or
(ii) applying a polyurethane formulation according to claim 1, with or without a top layer and with or without one or more interlayers, to a temporary support, inserting a substrate into the layer formed by the polyurethane formulation, and curing the polyurethane formulation.
